(19) United States
(12) Patent Application Publication
(10) Pub. No.: US 2025/0171970 A1
(43) Pub. Date: May 29, 2025

(54) MOTOR GRADER SNOW WING LINER

(71) Applicant: Caterpillar Inc., Peoria, IL (US)

(72) Inventor: Benjamin Kovalick, Chillicothe, IL (US)

(73) Assignee: Caterpillar Inc., Peoria, IL (US)

(21) Appl. No.: 18/519,116

(22) Filed: Nov. 27, 2023

(51) Int. Cl. E01H 5/06; E02F 3/76; E02F 3/815

(52) U.S. Cl. CPC E01H 5/067; E01H 5/066; E02F 3/7636; E02F 3/8152

(57) ABSTRACT

A snow wing assembly includes a snow wing moldboard having a material engaging side, a back side, and a plurality of openings formed in the material engaging side. The snow wing assembly also includes a plurality of attachment structures and a non-metallic liner having a first surface, a second surface, a leading side edge, a heel side edge, a top edge, a bottom edge, and a plurality of apertures extending between the first surface and the second surface. The first surface is configured to abut the material engaging side of the moldboard and the second surface is opposite the first surface and is configured to engage plowed material during a plowing operation. Each aperture of the liner is aligned with an associated opening of the moldboard, with an associated attachment structure extending through that aperture and fastened in an associated opening to secure the liner to the moldboard.

### TECHNICAL FIELD

This disclosure relates to a snow wing liner and an assembly for a snow wing, which is applicable to a motor grader machine that includes a mounted snow wing.

### BACKGROUND

Machines, such as motor graders, may use a moldboard in addition to attachments such as a snow wing or other snow blades to displace, move, distribute, and/or grade snow or other material. During a plowing operation, the motor grader may work in high speeds up to 8th gear, or low speeds with heavy loads, such as benching. For example, during a snow plowing operation, snow is displaced from a road surface and snow wings may be connected to motor graders to provide an extended range and capacity for the plowing operation.

Snow accumulation in regions of the world can be wet and heavy, or can be blown into deep drifts, and the amount of material a machine can move is limited by the tractive force, which can be reduced in snowy and icy conditions. Additionally, the snow may be mixed with rocks and other debris, which can cause the steel the moldboard is made of to become damaged as the material slides across the material engaging side of the moldboard. In some cases, thicker moldboards have been used, except the introduction of extra weight onto the machine can slow down plowing operations.

U.S. Pat. No. 10,883,236, assigned to Winter Equipment Company, (the '236 Patent) discloses an elastomeric plow edge segment. The '236 Patent has an elastomeric plow edge segment that is aligned proximal to the bottom edge of the moldboard. However, this design does not address potential damage to the rest of the material engaging side of the moldboard. Rather, it only addresses the blade that scrapes material from the road surface.

### SUMMARY

According to one aspect of the present disclosure, a snow wing assembly is disclosed. The snow wing assembly includes a snow wing moldboard having a material engaging side, a back side, and a plurality of openings formed in the material engaging side. The snow wing assembly also includes a plurality of attachment structures and a non-metallic liner having a first surface, a second surface, a leading side edge, a heel side edge, a top edge, a bottom edge, and a plurality of apertures extending between the first surface and the second surface. The first surface is configured to abut the material engaging side of the moldboard and the second surface is opposite the first surface and is configured to engage plowed material during a plowing operation of the motor grader machine. Each aperture of the non-metallic liner is aligned with an associated opening of the moldboard, with an associated attachment structure extending through that aperture and fastened in an associated opening to secure the non-metallic liner to the moldboard.

According to another aspect of the present disclosure, a work machine is disclosed. The work machine comprises a machine frame, a pair of front wheels and a pair of back wheels supporting the machine frame, an operator cab supported by the machine frame, and a snow wing assembly connected to the machine frame between the front wheels and back wheels. The snow wing assembly includes a snow wing moldboard having a material engaging side, a back side, a bottom side, and a plurality of openings formed in the material engaging side. The moldboard further includes a plurality of bosses, with each boss disposed in an associated opening, and a cutting edge connected to the material engaging side adjacent the bottom side and is configured to engage material on a work surface during a plowing operation of the motor grader machine. The snow wing assembly also includes a plurality of fasteners and a non-metallic liner having a first surface, a second surface, a leading side edge, a heel side edge, a top edge, and a bottom edge. The first surface abuts the material engaging side of the moldboard and the second surface is opposite the first surface and is configured to engage plowed material during a plowing operation. A plurality of apertures extends between the first surface and the second surface, wherein each aperture of the non-metallic liner is aligned with an associated boss in the moldboard and the non-metallic liner is secured to the moldboard using the fasteners and the bosses.

According to yet another aspect of the present disclosure, a non-metallic liner for a snow wing assembly is disclosed. The non-metallic liner is for a snow wing assembly of a motor grader machine, the snow wing assembly having a moldboard with a plurality of openings and a material engaging side. The liner has a generally flexible and sheet-like construction and comprises a first surface, a second surface, a leading side edge, a heel side edge, a top edge, a bottom edge, and a plurality of apertures. The first surface is configured to abut the material engaging side of the moldboard and the second surface is opposite the first surface and is configured to engage plowed material during a plowing operation of the motor grader. A length of the heel side edge is greater than a length of the leading side edge, and the liner has a thickness between the first surface and the second surface being in a range of 3 mm to 8 mm. The apertures extend between the first surface and the second surface, and the apertures are configured to align respectively with the openings of the moldboard.

### BRIEF DESCRIPTION OF DRAWINGS

FIG. 1 is a side elevational view of the motor grader and a snow wing assembly.

FIG. 2 is a front elevational view of the motor grader and the snow wing assembly.

FIG. 3 is an oblique perspective view of a portion of the snow wing assembly.

FIG. 4 is a front elevational view of a snow wing liner.

FIG. 5 is an exploded oblique front perspective view of the snow wing assembly.

FIG. 6 is a perspective view of a portion of the snow wing liner and attachment structure, including a cross-section, according to one embodiment.

FIG. 7 is an enlarged view of a portion of the snow wing liner and attachment structure of FIG. 6 enclosed by a dashed rectangle, according to one embodiment described herein.

FIG. 8 is an enlarged view of a portion of the snow wing liner and fastener of FIG. 6 enclosed by a dashed circle, according to one embodiment described herein.

FIG. 9 is a perspective close-up view of the cutting edge and the liner.

FIG. 10 is a side cross-sectional view of a snow wing assembly and attachment structure according to another embodiment.

FIG. 11 is a flowchart depicting a method of mounting a liner to a moldboard of a work machine.

### DETAILED DESCRIPTION

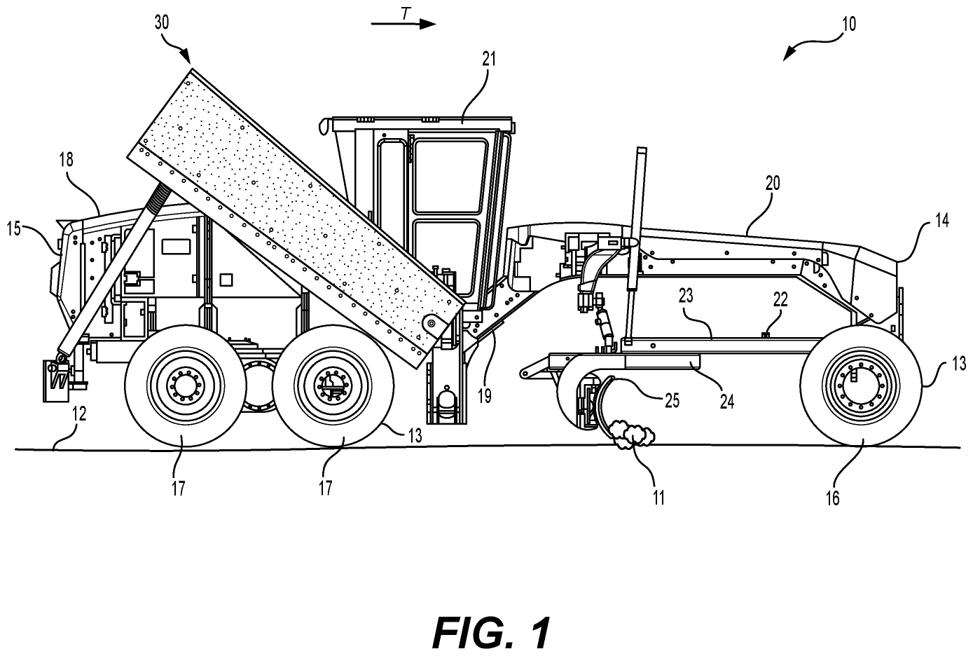

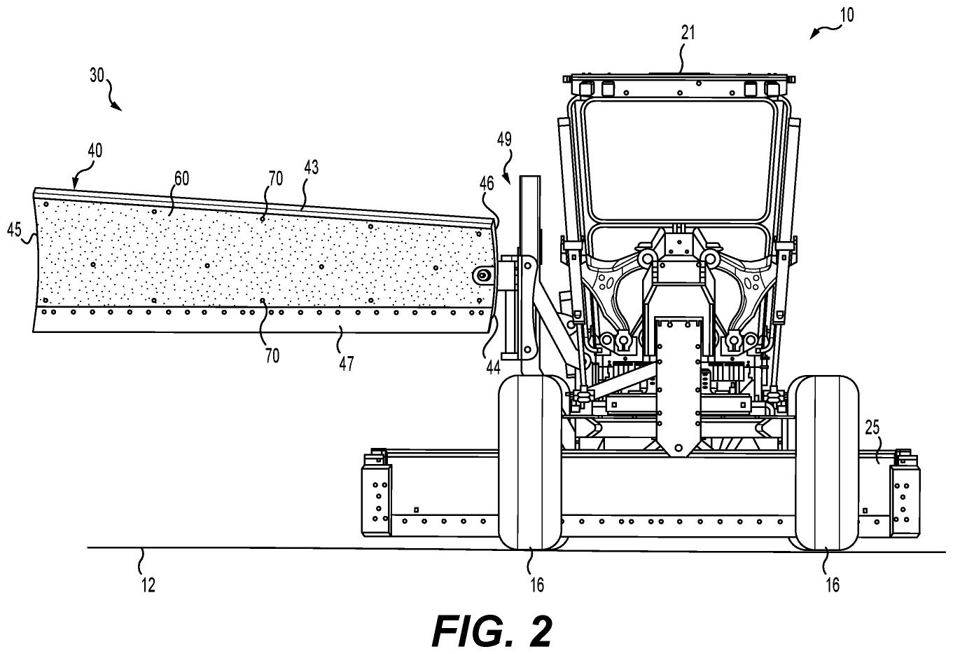

Beginning with FIGS. 1 and 2, a motor grader 10 is shown and includes traction devices 13, a power source 18, an undercarriage assembly 19, a sub-frame portion 20, an operator cab 21, a grader group 22, and a snow wing assembly 30. The motor grader 10 also may be referred to as a grader machine. The motor grader 10 may be used to perform plowing operations, such as displacing, spreading, distributing, leveling, and grading, materials or objects 11, such as snow, over a work surface 12. Generally, a grading operation is performed during machine movement, and for this purpose, the motor grader 10 may include traction devices 13 that facilitate machine movement over the work surface 12. For example, traction devices 13 include a set of front wheels 16 disposed towards a front end 14 of the motor grader 10 and a set of rear wheels 17 disposed towards the rear end 15 of the motor grader 10. The terms “front” and “rear,” as used herein, are in relation to an exemplary direction of travel of the motor grader 10, as represented by arrow T in FIG. 1, with the direction of travel being exemplarily defined from the rear end 15 towards the front end 14.

A movement of the traction devices 13 (e.g., a rotation of the set of front wheels 16 or the set of rear wheels 17) is powered by a power source 18, such as an engine (not shown in FIG. 1 or 2), housed in a power compartment of the motor grader 10. The motor grader 10 may also include an undercarriage assembly 19 and a sub-frame portion 20. The sub-frame portion 20 may be movable relative to the undercarriage assembly 19. Further, the motor grader 10 may include an operator cab 21 supported on the sub-frame portion 20. The operator cab 21 may house various controls of the power source 18 and other functions of the motor grader 10.

To perform plowing operations on materials or objects 11, the motor grader 10 includes a drawbar-circle-blade (DCB) arrangement, which may also be referred to as a grader group 22. The grader group 22 may be supported by the sub-frame portion 20, and may include a drawbar 23, a circle member 24, and a blade 25, each of which may function in concert to perform a plowing operation on the work surface 12. The blade 25 of the grader group 22 has a generally central location relative to the motor grader 10 and is a structure which engages material on the work surface 12. The terms “blade” and “moldboard” may be used interchangeably herein.

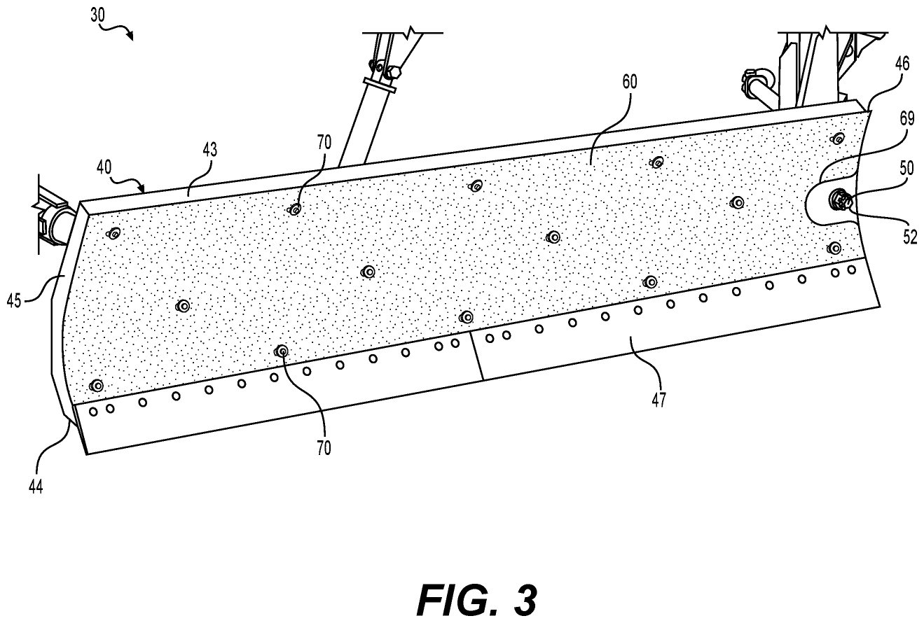

FIG. 3 illustrates a snow wing assembly 30 which generally includes a snow wing moldboard 40, a non-metallic liner 60 for covering a portion of the moldboard 40, and a plurality of attachment structures 70 for securing the liner 60 to the moldboard 40. The snow wing assembly 30 may be mounted on a side of the motor grader 10 such as on a side of the operator cab 21. As shown in FIG. 2, the snow wing assembly 30 is mounted on the right-hand side of the machine relative to the operator cab 21 and direction of travel T. The snow wing assembly 30 may alternatively be mounted on the left-hand side of the machine relative to the operator cab 21. In other examples, the snow wing assembly 30 may be mounted to the sub-frame.

When snow accumulation occurs, the snow wing moldboard 40 may additionally be attached to the machine on a side adjacent the grader group 22. Similar to the blade 25 of the grader group 22, the snow wing moldboard 40 engages material, but also provides an extended widthwise range and capacity for plowing operations. The snow wing moldboard 40 may include six sides: a material engaging side 41, a back side 42, a top side 43, a bottom side 44, a heel side 45, and a leading side 46. References herein to “leading” and “heel” are directed to the snow wing moldboard 40 placement relative to the operator cab 21. It should be understood that “leading” refers to a position that is closer to the operator cab 21, and “heel” refers to a position that is farther from the operator cab 21.

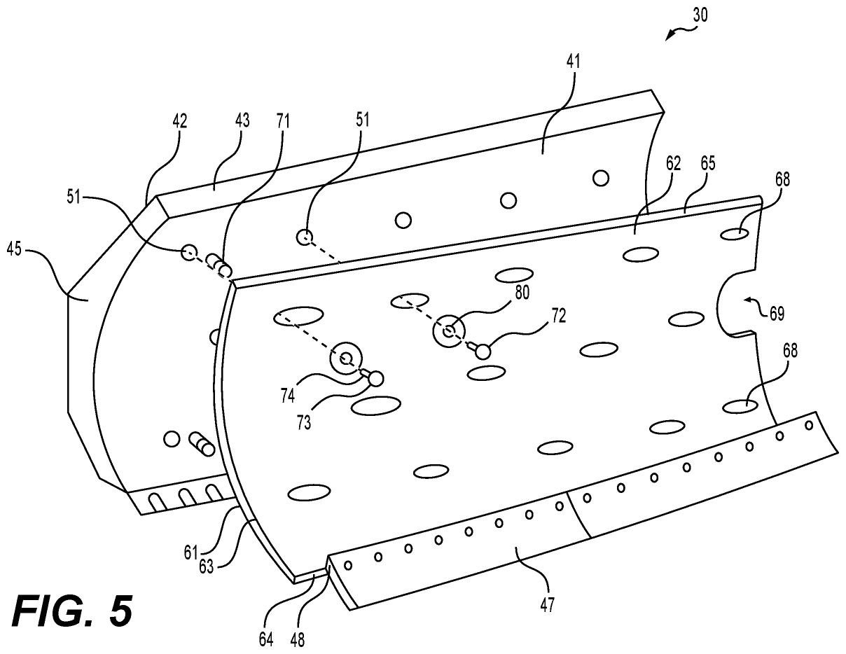

The material engaging side 41 (visible in FIG. 5), which has a curved surface or a concave surface, helps receive and agglomerate the snow over the work surface 12. Opposite of the material engaging side 41 is the back side 42, on the opposite side of the snow wing moldboard 40 (not shown in FIGS. 1 and 2). Connecting the material engaging side 41 and the back side 42 is the bottom side 44, top side 43, heel side 45 and leading side 46. The bottom side 44 is located closer to the work surface 12 and the top side 43 is a corresponding side opposite the bottom side 44. Disposed within the snow wing moldboard 40 are a plurality of openings 51 that extend from the material engaging side 41 to the back side 42, which will be discussed in further detail subsequently. Alternatively, openings 51 could be blind holes formed in the material engaging side that stop short of penetrating to back side 42.

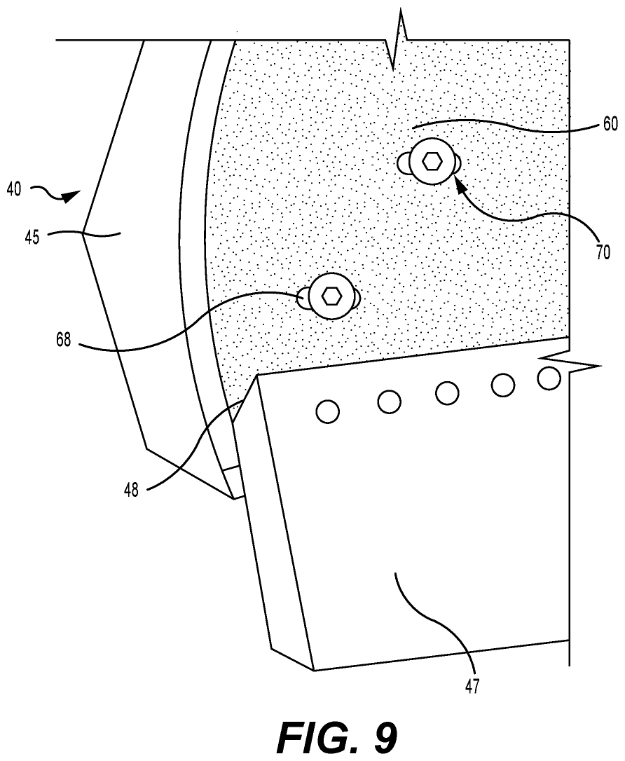

A cutting edge 47 is attached to a lower portion of the material engaging side 41 and extends along a lengthwise extent of the snow wing moldboard 40 on the material engaging side 41 and helps engage and scrape the materials such as snow 11 off the work surface 12 and distribute, level, and grade the work surface 12, during a plowing operation. As described further below with respect to FIG. 9, the cutting edge 47 includes a notch 48 which also extends along the lengthwise extent of the snow wing moldboard 40. The notch 48 creates an angled space on a side adjacent the material engaging side 41.

The snow wing assembly 30 may be coupled to the motor grader 10 via a lift assembly 49. The lift assembly 49 may be configured to link the snow wing assembly 30 to the sub-frame portion 20 of the motor grader 10. The lift assembly 49 may include one or more lifting mechanisms, such as one or more actuators (e.g., hydraulic actuators or pneumatic actuators) or other components configured to raise or lower the snow wing assembly 30 relative to the work surface 12. Additionally, the lift assembly 49 may be configured to angle or tilt the snow wing moldboard 40 about one or more axes.

The snow wing assembly 30 may enable the motor grader 10 to perform operations, which may involve grading or distributing materials from an elevated surface (e.g., elevated relative to the work surface 12). For example, the snow wing moldboard 40 may be used to remove, grade, or distribute snow from a top portion of a bank. As shown in FIG. 1, the snow wing assembly 30 may be coupled to the lift assembly 49 proximate to the leading end or the heel end of the snow wing moldboard 40.

The snow wing assembly 30 may be coupled to the lift assembly 49 via a connecting assembly 50. The connecting assembly 50 may enable the snow wing assembly 30 to rotate in multiple rotational directions. In some cases, the connecting assembly 50 may include a fastening system that extends forwardly past the material engaging side 41 of the snow wing moldboard 40. For example, a pin 52 which enables the snow wing moldboard 40 to rotate, is visible on the material engaging side 41, as shown in FIG. 3.

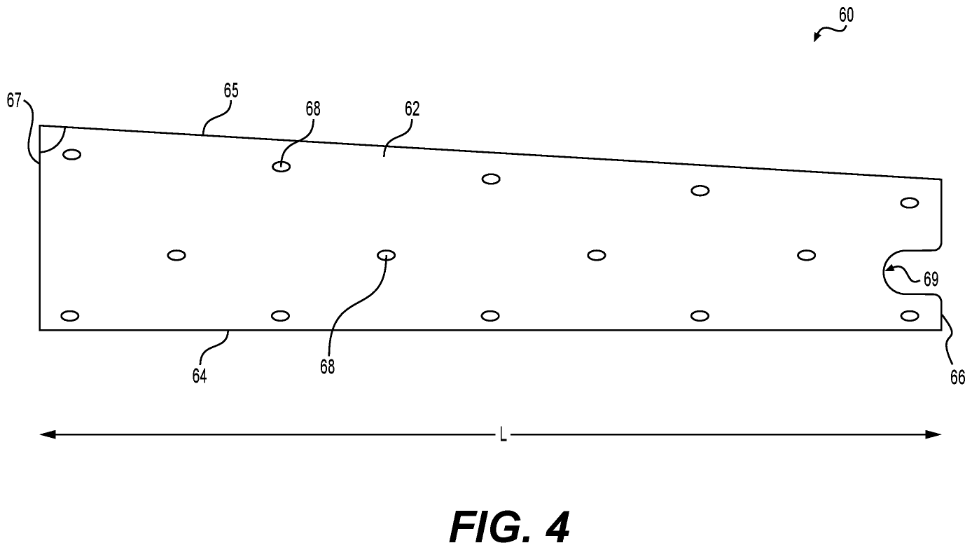

FIG. 4 shows a non-metallic snow wing liner 60, such as before it is attached to the snow wing moldboard 40. The non-metallic liner 60 may also be referred to as a snow wing wear liner 60, a snow wing liner 60, a protective liner 60 and/or a liner 60. As depicted, the liner 60 has a generally rectangular shape, but in other examples, contemplated shapes include other configurations which provide significant coverage on the material engaging side 41 of the snow wing moldboard 40.

The liner 60 has a generally flexible and sheet-like construction. Such a liner 60 may be made of or formed of a polymer, a composite, an elastomeric material, a plastic, or the like. Such materials and others may provide high abrasion resistance, and high impact durability, reducing wear on the material engaging side 41 of the snow wing moldboard 40. Composites made with polyethylene and/or urethanes are contemplated, preferably, having a coefficient of friction less than 25% that of the material, for example, steel, used to form the snow wing moldboard 40. Additionally, the low coefficient of friction of the liner 60 may reduce the amount of force that the motor grader 10 must apply to shift a given amount of snow 11, meaning that when the motor grader 10 having liner 60 reaches its traction limit it can shift more snow 11 than if it did not have the liner 60. Preferably, the liner 60 is made of material having abrasion resistance that is at least 50% greater than that of the material used to form the snow wing moldboard, for example, steel.

The liner 60 includes a first surface 61, a second surface 62, and have a thickness 63 therebetween ranging from about 3 mm to about 8 mm. The liner 60 has two long sides and two short sides. The long sides include a bottom edge 64, which is closer to the work surface 12 when attached to the machine, and a top edge 65, which is generally opposite the bottom edge 64. The short sides include a leading side edge 66, which is closer to the operator cab 21 when attached, and a heel side edge 67, which is generally opposite the leading side edge 66. As depicted, the heel side edge 67 can have a length that is greater than a length of the leading side edge 66, creating an angle less than 90 degrees where the heel side edge 67 and top edge 65 intersect and an angle greater than 90 degrees where the leading side edge 66 and the top edge 65 intersect.

A plurality of apertures 68 extend from the first surface 61 to the second surface 62. The apertures 68 may be positioned in horizontal rows, vertical rows, or in other arrangements which allow for alignment with features of the snow wing moldboard 40. As depicted, the apertures 68 are arranged in three rows. Each aperture 68 is generally oval (elongated), having a length distance greater than a height distance, but alternative shapes may also be used which provide the appropriate securement function described subsequently. Irregular patterns of apertures are also contemplated, and liner performance may be improved by having more apertures in regions that experience higher loading forces.

Adjacent the leading side edge 66, the liner 60 includes a connecting assembly cut-out 69 (also referred to as a notch). The connecting assembly cut-out 69 enables the liner 60 to retain its compatibility and ease of installation on snow wing moldboards 40 which have attachments present on the material engaging side 41, such as the pin 52 described above. The connecting assembly cut-out 69 extends from the leading side edge 66 toward the heel side edge 67 but does not extend to either the top edge 65 or the bottom edge 64. For example, the connecting assembly cut-out 69 extends no more than ⅛th the length L of the liner 60 in the widthwise direction.

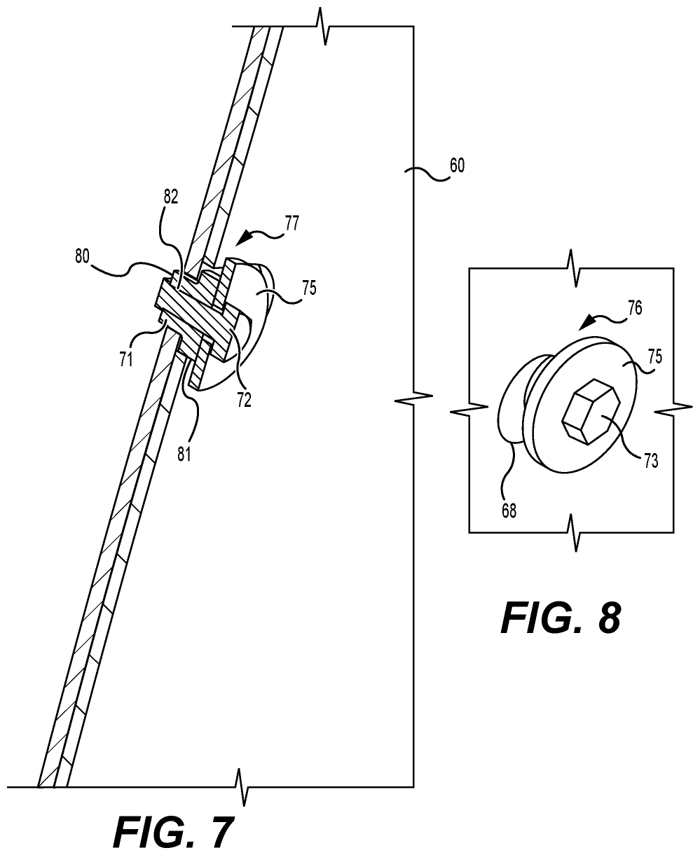

FIG. 5 is an exploded view showing the general relationship of the snow wing moldboard 40, liner 60, and cutting edge 47. When attaching the liner 60 to the snow wing moldboard 40, the first surface 61 is abutted against the material engaging side 41, the bottom edge 64 is disposed within the notch 48 of the cutting edge 47, and the second surface 62 opposing the first surface 61 is exposed. Once the liner 60 is applied, the liner 60 is disposed across the entire material engaging side 41 and the second surface 62 is configured to engage material. The attachment structures 70 connect to secure the liner 60 to the snow wing moldboard 40 by extending through the apertures 68. FIGS. 7 and 8 show the attachment structures 70, which include a boss 71, affixed to the snow wing moldboard 40, a bolt 72, having a threaded shaft 74 and a bolt head 73, and a washer 75 having a first side, a second side, an outer circumference, and a washer bore.

Referring to FIG. 5, to attach the liner 60 to the snow wing moldboard 40, the liner 60 is aligned with the plurality of bosses 71 disposed in the openings 51 of the snow wing moldboard 40. Openings 51 may extend between the material engaging side 41 and the back side 42 of moldboard 40. As previously noted, openings 51 could be blind bores formed in the material engaging side 41 of moldboard 41. The number of openings 51 present in the snow wing moldboard 40 corresponds to the number of apertures 68 within the liner 60 (the number of apertures 68 could differ from the number of openings 51, with some apertures not being used for securement). Each boss 71 is respectively welded or otherwise fastened into an opening 51, such that the bosses 71 extend outwardly beyond the material engaging side 41 of the snow wing moldboard 40. When attaching the liner 60, each aperture 68 is then aligned with a corresponding opening 51 and the liner 60 surrounds the portion of each boss 71 that extends outwardly beyond the material engaging side 41. In some embodiments, not all openings 51 will receive bosses 71.

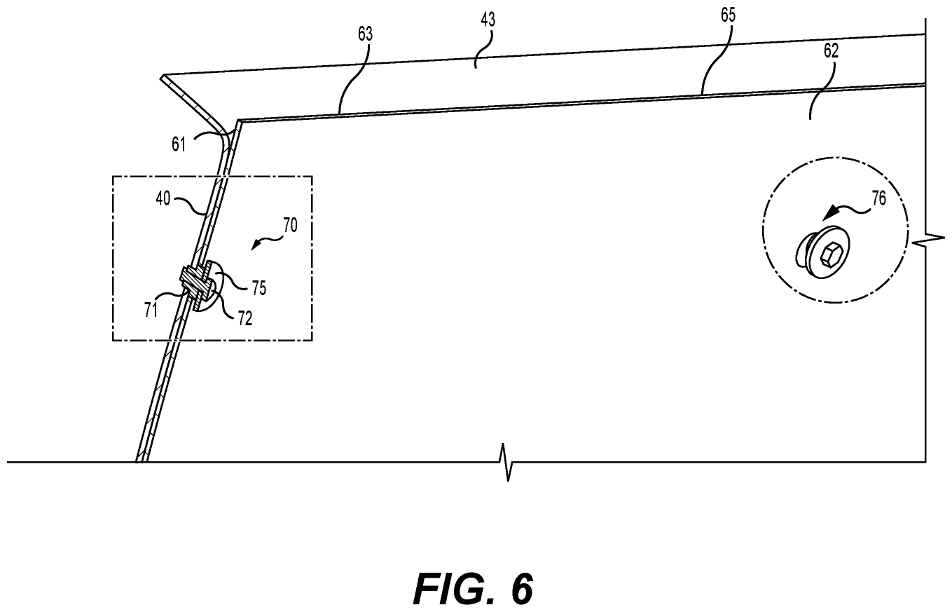

FIGS. 6, 7, and 8 are perspective views with increasing degrees of detail depicting an attachment structure 70, fastener 76, and aperture 68 according to one embodiment described herein. Once the bosses 71 have been affixed to the snow wing moldboard 40, a connection to the liner 60 can be performed via a plurality of fasteners 76 to construct rigid joints. Each washer 75 is configured to abut a boss 71 and a bolt head 73. A shaft 74 of bolt 72 extends through the washer 75 and the liner 60 and is coupled to the boss 71. When secured, each washer 75 respectively abuts both a bolt head 73 and a boss 71. Securing each washer 75 onto a boss 71 using the bolt 72 establishes a clearance space 77 between the washer 75 and the snow wing moldboard 40. The clearance space 77 is generally greater than the thickness 63 of the liner 60 to accommodate expansion and contraction of the liner 60, such as might occur under different temperature conditions. Once the liner 60 is secured in the clearance space 77 between the washer 75 and snow wing moldboard 40, the clearance space 77 and the shape of the apertures 68 allow limited lateral and/or vertical movement of the liner 60 when installed (movement of the liner 60 relative to the material engaging side of the snow wing moldboard 40 stops when respective edges of the apertures 68 come into contact with portions of the bosses 71 and/or undersides of the washers 75).

The fasteners 76 are a part of the attachment structure 70 and include the bolt 72 and the washer 75. The term “fasteners” is used to connote mechanical connection mechanisms that provide a rigid joint. Such fasteners 76 can also include, but are not limited to bolts, rivets, self-tapping screws, washers, or the like. Glue may be utilized but is not contemplated in all examples.

FIG. 9 illustrates a bottom edge 64 (not shown) of the liner 60 disposed behind the cutting edge 47. When attached, the top edge 65 of the liner 60 generally extends to the top side 43 of the snow wing moldboard 40 such as shown in FIGS. 1 and 2. The liner 60 generally extending to the top side 43 of the snow wing moldboard 40 allows for sufficient coverage of the snow wing moldboard 40 and permits the addition of a snow wing lip 78 to the snow wing moldboard 40, which will be discussed in further detail subsequently.

In other examples, the liner 60 may extend past the top side 43, such as in FIG. 6, and/or the leading side 46 and heel side 45 such as in FIG. 3. Each liner 60 is intended to be retrofittable for snow wing moldboards 40 so that liners 60 larger than snow wing moldboard 40 may still be utilized. In cases where the liner 60 is larger than the snow wing moldboard 40, the liner 60 will extend past the top side 43. Additionally, or alternatively, liners 60 larger than the size intended for the snow wing moldboard 40 may extend past the leading side 46 and the heel side 45.

In either case, the bottom portion of the liner 60 is disposed between a portion of the cutting edge 47 and the material engaging side 41. The notch 48 located adjacent the material engaging side 41 is specifically where the liner 60 is positioned. The bottom edge 64 being disposed between the cutting edge 47 and material engaging side 41 allows plowed material, such as snow, to slide across the second surface 62 without disrupting the liner 60.

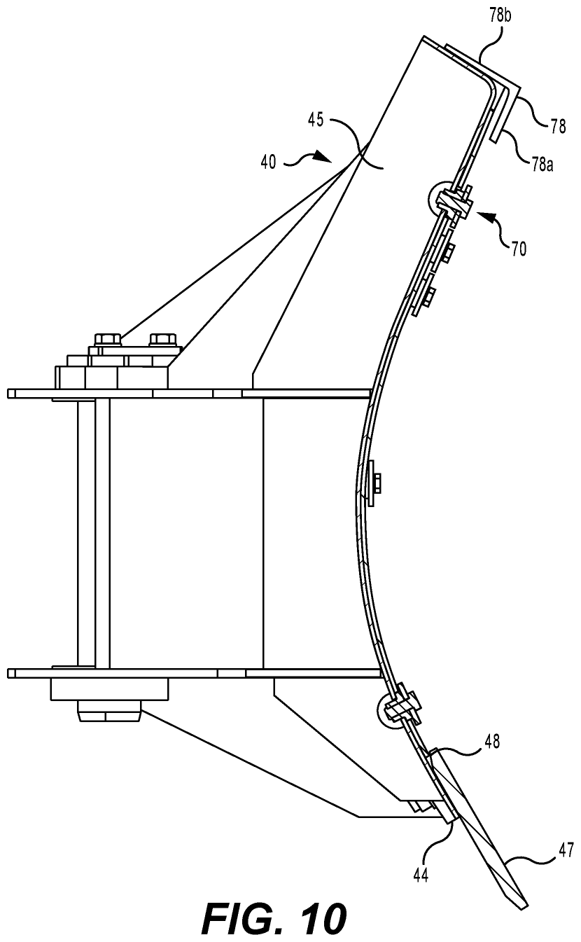

FIG. 10 illustrates another example of the attachment structure 70 used to secure the liner 60 to the snow wing moldboard 40. As depicted, in addition to the bolt 72, washer 75, and boss 71, the attachment structure 70 further includes a snow wing lip 78. The snow wing lip 78 allows alternative positioning of the openings 51 and apertures 68 as well as an alternative mode of fastening. The bolt 72, washer 75, and boss 71 are still constructed in the manner described above to provide the clearance spaces needed for contraction and expansion.

The snow wing lip 78 is attached to the top side 43 of the snow wing moldboard 40 and extends the length of the top side 43. The snow wing lip 78 also has an angled shape (e.g., “L”-shaped), with one leg 78a extending toward the bottom edge 64 and covering a portion of the material engaging side 41 of the snow wing moldboard 40. The top edge 65 of the liner 60 is disposed behind the leg 78a of the snow lip 78 which covers the portion of the material engaging side 41. As shown in FIG. 10, snow wing lip 78 is dimensioned so that there is a gap between the second surface 62 of liner 60 and the rearward surface of leg 78a. Leg 78b is attached to the top side 43 of snow wing moldboard 40.

### Industrial Applicability

In general, the snow wing, liner 60, and motor grader 10 machine described above are relevant to plowing operations in regions of snow accumulation. More specifically, the liner 60 protects the material engaging side of snow wing moldboards 40 from becoming damaged during use. Securing and removing the liner 60 is intended to be a quick and easy process, while being cost-effective.

The liner 60 may be laser cut from a flexible flat sheet and then pressed, which allows for easy manufacturing, shipping, storage, and handling. When attached to the snow wing, the attachment structures 70 and the flexible and sheet-like construction of the liner 60 enables the motor grader 10 to perform plowing operations without reduced speed due to additional weight. In addition to a minimal change in load on the motor grader 10 from the liner 60 and the attachment structures 70, replacing individual components of the attachment structure 70 and the liner 60 itself is meant to be more cost-effective than replacing the snow wing moldboard 40.

The liner 60 is designed to be retrofittable to any snow wing for a motor grader 10. The retrofittable attribute of the liner 60 enables the use of liners 60 that are so large as to extend outwardly past the snow wing moldboard 40 sides. Alternatively, the retrofittable attribute allows the use of liners 60 that are smaller than the snow wing, although that will leave an area adjacent each side of the snow wing moldboard 40 exposed. In some examples, a plurality of openings 51, extending through the snow wing moldboard 40, would need to be drilled or otherwise formed prior to installation of the liner 60 for some snow wing moldboards 40. After the openings 51 have been drilled, a plurality of bosses 71 would then be welded or otherwise secured into the openings 51. This is a process designed to be done sparingly, with the need to only replace bosses 71 as they become damaged, or after they have excessive wear. In other examples, snow wing moldboards 40 are manufactured with a plurality of openings 51, making the snow wing moldboard 40 ready for the boss welding process.

By providing and attaching a liner 60 as described, wear of the supporting snow wing moldboard 40 can be reduced. The liner 60 can be considered a wear part which is replaced periodically, preventing damage to the blade of the snow wing moldboard 40.

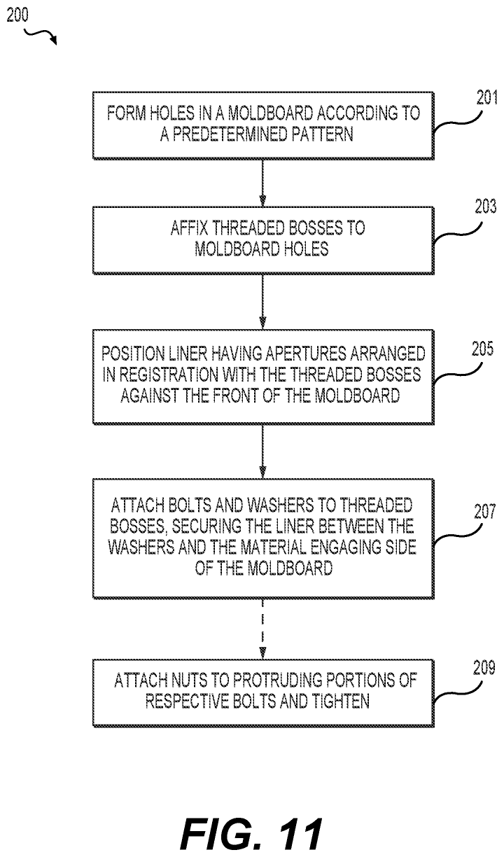

In according with the foregoing embodiments, a liner 60 can be installed on the moldboard 40 of a motor grader 10 or blade of another work machine through the method 200 depicted in FIG. 11 and described below.

In step 201, holes 51 are formed in a moldboard 40 according to a predetermined pattern. The holes 51 can be formed as described above, or in other ways.

In step 203, threaded bosses 71 are affixed to the moldboard holes 51, with a neck portion 80 of each boss 71 extending at least partially through the associated moldboard hole 51. As described above, this affixation can take place from the material engaging side 41 of the moldboard 40. Optionally, the threaded bosses can be affixed by welding, and such welding could be performed on the front, rear, or both sides of the moldboard 40. Also optionally, instead of having neck portions 80 and head portions 81, the bosses 71 could be of constant or monotonically-increasing elongate shape, for example, cylindrical or frusto-conical.

In step 205 a liner 60 having a set of apertures 68 arranged in registration with the pattern of threaded bosses 71 is positioned against the material engaging side 41 (front) of the moldboard 40 such that a head portion 81 of each threaded boss 71 passes through the aperture 68 with which it is in registration. In an embodiment at least some of the apertures 68 are elongated such that a length along one axis is greater than a length along another axis.

In step 207 bolts 72 and washers 75 are attached to respective threaded bosses 71, thereby securing the liner 60 between the washers 75 and the material engaging side 41 (front) of the moldboard 40. As outlined above, the components are sized to provide a liner clearance space 77 between the washer 75 and the liner 60, this liner clearance space and the elongated shape of the apertures 68 allowing limited lateral and/or vertical movement of the liner 60 when installed.

In optional step 209, nuts can be attached to protruding portions of respective bolts 72 and tightened, thereby preventing the bolts 72 from working loose during machine operation. To further prevent the bolts 72 from loosening, lock nuts, lock washers, or thread locking agents can be employed.

It may be desirable to perform one or more of the steps shown in FIG. 11, and/or described above, in an order different from that depicted and/or described. One or more of the steps shown in FIG. 11, and/or described above, could be omitted. Furthermore, various steps could be performed together.

Another embodiment involves a method of forming a motor grader blade assembly by the steps of forming a plurality of holes in a moldboard, the holes being arranged with a predetermined pattern, affixing, respectively, a plurality of bosses to the holes, positioning a protective liner, having a plurality of elongate apertures arranged in registration with the bosses, against a front surface of the moldboard, and attaching, respectively, a plurality of fasteners and a plurality of washers to the bosses, such that the protective liner is secured between the washers and the front surface of the moldboard. Optionally, the bosses can have threaded internal bores. Also optionally, the affixing of the bosses can be by welding. Additionally, the fasteners can be threaded fasteners, and the method may include attaching, respectively, a plurality of nuts to the threaded fasteners. Optionally, the protective liner may be secured between the washers and the front surface of the moldboard in a clearance space that is at least 8 mm in depth. The method also may involve securing a first portion of a lip member extending in a widthwise direction of the moldboard to the moldboard, a second portion of the lip member covering at least a portion of a top edge of, and limiting movement of, the protective liner.

Although the foregoing embodiments involve a motor grader's snow wing, this disclosure is not limited thereto, and could be applied to other motor grader blades/moldboards, such as the primary moldboard. Use on other work machines is also contemplated.

It also should be understood that the various components illustrated herein are not necessarily drawn to scale. In other words, the features disclosed in various embodiments may be implemented using different relative dimensions within and between components than those illustrated in the drawings. Also, the scale and proportions of one drawing may differ from the scale and proportions of another drawing. It is also understood that the illustrations may include exaggerated dimensions and graphical representations to better illustrate the referenced items shown, and are not considered limiting unless expressly stated as such.

As used herein, the terms “respective” and “associated” signify a relationship between members of a group of first components and members of a group of second components (e.g., A1 and B1; A2 and B2; . . . . AN and BN). More than two groups of components can have respective or associated relationships (e.g., A1, B1, C1 . . . . N1).

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B″) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

1. A snow wing assembly for a motor grader machine, comprising:
a snow wing moldboard having a material engaging side, a back side, and a plurality of openings formed in the material engaging side;
a plurality of attachment structures; and
a non-metallic liner including:
a first surface, a second surface, a leading side edge, a heel side edge, a top edge, a bottom edge, and a plurality of apertures extending between the first surface and the second surface;
the first surface being configured to abut the material engaging side of the moldboard;
the second surface being opposite the first surface and configured to engage plowed material during a plowing operation of the motor grader machine; and
each aperture of the non-metallic liner being aligned with an associated opening of the moldboard, with an associated attachment structure extending through that aperture and fastened in an associated opening to secure the non-metallic liner to the moldboard.

2. The snow wing assembly of claim 1, wherein the moldboard has a bottom side and further includes a cutting edge connected to the material engaging side adjacent the bottom side, the cutting edge being configured to engage material on a work surface during a plowing operation, and
wherein the bottom edge of the non-metallic liner is disposed between a portion of the cutting edge and the moldboard.

3. The snow wing assembly of claim 2, wherein the cutting edge further includes a notch which extends along a lengthwise extent of the moldboard on a side adjacent the material engaging side, and
wherein a portion of the liner is positioned in the notch.

4. The snow wing assembly of claim 1, wherein a length of the heel side edge is greater than a length of the leading side edge.

5. The snow wing assembly of claim 4, wherein the moldboard includes a top side and the top edge of the non-metallic liner extends at least to the top side.

6. The snow wing assembly of claim 1, wherein each attachment structure includes a bolt, a boss affixed to the moldboard, and a washer.

7. The snow wing assembly of claim 6, wherein the openings extend between the material engaging side and the back side, and each boss extends through an associated opening of the moldboard, and each boss has an opening,
each bolt extends through an associated washer, an associated aperture of the non-metallic liner, and an associated opening of the associated boss, and is coupled to that associated boss, and
each washer respectively abuts both the associated bolt and the associated boss,
wherein a clearance space is defined between each washer and the moldboard, and the non-metallic liner is positioned in the clearance space.

8. A motor grader work machine, comprising:
a machine frame;
a pair of front wheels and a pair of back wheels supporting the machine frame;
an operator cab supported by the machine frame; and
a snow wing assembly connected to the machine frame between the front wheels and back wheels, the snow wing assembly having:
a snow wing moldboard having a material engaging side, a back side, a bottom side, and a plurality of openings formed in the material engaging side;
the moldboard further having a plurality of bosses, with each boss disposed in an associated opening, and a cutting edge connected to the material engaging side adjacent the bottom side and configured to engage material on a work surface during a plowing operation of the motor grader machine;
a plurality of fasteners; and
a non-metallic liner including:
a first surface, a second surface, a leading side edge, a heel side edge, a top edge, and a bottom edge;
the first surface abutting the material engaging side of the moldboard; and
the second surface being opposite the first surface and configured to engage plowed material during a plowing operation; and
a plurality of apertures extending between the first surface and the second surface,
wherein each aperture of the non-metallic liner is aligned with an associated boss in the moldboard and the non-metallic liner is secured to the moldboard using the fasteners and the bosses.

9. The motor grader work machine of claim 8, wherein the bosses extend outwardly beyond the material engaging side of the moldboard, and
each aperture of the non-metallic liner surrounds a portion of the associated boss that extends beyond the material engaging side.

10. The motor grader work machine of claim 9, wherein the plurality of fasteners includes a plurality of bolts and a plurality of washers,
each bolt extending through an associated aperture of the non-metallic liner and threadably coupled to the associated boss, and
each washer abutting both an associated bolt and the associated boss,
whereby a clearance space is defined between each washer and the moldboard and the liner is positioned in the clearance space and is free to move in the lateral and vertical directions with respect to the moldboard.

11. The motor grader work machine of claim 10, wherein the non-metallic liner has a thickness of between 3 mm and 8 mm.

12. The motor grader work machine of claim 11, wherein the non-metallic liner has a thickness less than a length of the clearance space, thereby allowing lateral or vertical movement of the liner.

13. The motor grader work machine of claim 12, wherein the moldboard includes a top side and the top edge of the non-metallic liner extends at least to the top side.

14. The motor grader work machine of claim 12, wherein the moldboard has a bottom side and further includes a cutting edge connected to the material engaging side adjacent the bottom side, the cutting edge being configured to engage material on a work surface during a plowing operation, and
wherein the bottom edge of the non-metallic liner is disposed between a portion of the cutting edge and the moldboard.

15. The motor grader work machine of claim 14, wherein the cutting edge further includes a notch which extends along a lengthwise extent of the moldboard on a side adjacent the material engaging side, and
wherein a portion of the liner is positioned in the notch.

16. A non-metallic liner for a snow wing assembly for a motor grader machine, the snow wing assembly having a moldboard with a plurality of openings and a material engaging side, the liner having a generally flexible and sheet-like construction and comprising:
a first surface, a second surface, a leading side edge, a heel side edge, a top edge, a bottom edge, and a plurality of apertures;
the first surface being configured to abut the material engaging side of the moldboard;
the second surface being opposite the first surface and configured to engage plowed material during a plowing operation of the motor grader;
a length of the heel side edge being greater than a length of the leading side edge;
a thickness between the first surface and the second surface being in a range of 3 mm to 8 mm; and
the apertures extend between the first surface and the second surface, the apertures being configured to align respectively with the openings of the moldboard.

17. The non-metallic liner of claim 16, further comprising a connecting assembly cut-out extending from the leading side edge toward the heel side edge and between but not reaching the top edge and the bottom edge, the cut-out being configured to fit around a connecting assembly that connects the moldboard to the motor grader machine.

18. The non-metallic liner of claim 16, wherein the heel side edge and the top edge intersect at an angle that is less than 90 degrees.

19. The non-metallic liner of claim 16, wherein each aperture is elongated, having a length distance that is greater than a height distance.

20. The non-metallic liner of claim 16, wherein the apertures are disposed across the non-metallic liner in at least three rows.
